(19) United States
(12) Patent Application Publication
(10) Pub. No.: US 2025/0078015 A1
(43) Pub. Date: Mar. 6, 2025

(54) Cargo Transportation System and Methods

(71) Applicant: VESSEY LLC, JANESVILLE, WI (US)

(72) Inventors: Brandon JOHNSON, EDGERTON, WI (US); Jared WALLACE, JANESVILLE, WI (US); Tim LEONARD, CEDAR PARK, TX (US); Joe HARVEY, PARDEEVILLE, WI (US); Chris TRANEL, BLUE MOUNDS, WI (US)

(73) Assignee: VESSEY LLC, JANESVILLE, WI (US)

(21) Appl. No.: 18/598,214

(22) Filed: Mar. 7, 2024

Related U.S. Application Data
(63) Continuation-in-part of application No. 18/163,532, filed on Feb. 2, 2023.
(60) Provisional application No. 63/327,547, filed on Apr. 5, 2022.

(51) Int. Cl. G06Q 10/0833; G06F 16/23

(52) U.S. Cl. CPC G06Q 10/0833; G06F 16/2379

(57) ABSTRACT

Methods and systems for tracking freight and certifying the freight. The methods and systems include producing a blockchain ledger having individual blocks comprising special and temporal data of the freight. The individual nodes in the ledger enter information about the freight so that the authenticity of the freight and the transportation conditions can be verified.

### RELATED APPLICATIONS

This application is a continuation-in-part of co-pending U.S. patent application Ser. No. 18/163,532, filed 2 Feb. 2023, which claims the benefit of U.S. provisional application Ser. No. 63/327,547 filed 5 Apr. 2022.

### FEDERALLY SPONSORED DEVELOPMENT

This invention is made with government support under USDA-NIFA-SBIR-007712 awarded by the United States Department of Agriculture. The government has certain rights in the invention.

### BACKGROUND OF THE INVENTION

The present invention is related to cargo transportation systems, and, more particularly to food transportation systems.

Modern food transportation systems require close maintenance and monitoring so that the foods being transported are not contaminated or compromised during the transport of the foods. More and more foods are transported in tanks and holding containers that dictate the container have dietary requirement, such as free from allergens, e.g. free from nuts or dairy. To ensure that containers meet stated requirements, certificates are stated that the container meets certain stated requirements, and these certificates are verified at various points along the transportation process. Similarly, religious dietary requirements, such as being kosher, can be required for transportation. Maintaining the requirements throughout the delivery process and throughout repeated uses are necessary so that there is confidence in the process, as well as to track any possible contaminants in the system.

While there are processes currently in place to track transportation, there are still opportunities that the systems may be compromised with the entry of incorrect data or incorrect procedures when cleaning the transport containers. Currently, tracking and tracing is done manually, which is subject to human error or, and in the worst cases, alteration or falsification. Further, improperly cleaned trailers and inaccurate or inaccessible documentation can lead to severe illness or death if allergens or contaminants are not properly cleaned and documented and end up in processing plants or in consumer foodstuffs. In addition to this the current methods of tracking and documentation can lead to tankers being rejected prior to loading or, even worse, at the delivery due to inaccurate information being present on paperwork.

### SUMMARY OF THE INVENTION

The present invention is directed to a secure transportation system for food products and other goods, as well as methods to securely transport goods. The transportation systems incorporates immutable storage means to securely transport the goods. One type of immutable storage means that is used in the present invention is the use of block chain. The system and methods provide a block chain record of the transported goods that can be verified at each step of the delivery process. The systems and methods will use QR codes, RFID, or other similar tracking devices to enter information from each step of the process.

The present invention further is directed towards certification processes so that containers used in transporting goods can be verified at each step of transporting the goods. Certification can be confirmed so that the characteristics of the container are maintained throughout transportation.

The present invention also provides delivery and transportation systems that meet dietary constraints and are tracked and verified in a secure manner. The present invention can record and verify various steps during a process and also prevent the information from being modified or changed. For example, the present invention can record when a tanker truck is washed, loaded, and delivered, and who carried out each of the various steps.

The present invention further comprises a distributed ledger or blockchain recordation that will trace both the wash and commodity hauling history of tankers used to haul liquid freight. The resulting data will describe the presence of allergens, potential for cross contamination, quality assurance, and verification that vessel certifications (e.g. kosher certification, Halal certification, etc.) have been maintained through the chain of custody by accurately and securely recording commodities transported and trailer wash history.

### BRIEF DESCRIPTION OF THE DRAWINGS

FIG. 1 is a flowchart showing various uses of the present invention.

FIG. 2 is a tanker truck that can be used for the delivery for the present invention.

FIG. 3 is a rear view of the tanker truck shown in FIG. 2 with a QR code located on the rear of the truck.

FIG. 4 demonstrates the tanker truck of FIG. 2 being filled.

FIG. 5 shows the tanker truck after being filled.

FIG. 6 demonstrates the QR code on the tanker truck being scanned and the data recorded.

FIG. 7 demonstrates the tanker truck being unloaded.

FIG. 8 shows the tanker truck after it has been emptied.

FIG. 9 is a cut away view of the tanker truck of FIG. 8.

FIG. 10 shows the tanker truck being washed.

FIG. 11 demonstrates the tanker truck being washed.

FIG. 12 shows a washed tanker truck.

FIG. 13 demonstrates the various steps carried out during the process.

FIG. 14 is an example of a flow chart for the program carried out according

to the present invention.

FIG. 15 is a further flow chart according to the present invention.

FIGS. 16a and 16b is a further flow chart according to the present invention.

FIGS. 17a and 17b show a further flow chart according to the present invention.

FIG. 18 further demonstrates a network setup according to the present invention.

FIG. 19 provides yet another example of a flowchart according to the present invention for developing a ledger.

FIG. 20 is an example of hashed transaction information that is captured by the present invention.

FIG. 21 shows an example of the user interface used that could be used to carry out the present invention.

FIG. 22 shows an example of a certification acknowledgment for the present invention.

### DETAILED DESCRIPTION OF THE INVENTION

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

As will be appreciated from the discussion below, the present invention provides a secure delivery and transportation system that can be used in a range of activities wherein the chain of custody is important, particularly in situations where the environment is an open environment, for example in transport of goods and services over roads and railroads. The present invention provides verification certificates that are not entered manually, but are part of the program of the present invention, which cannot be altered or changed without a permanent record of the change being noted.

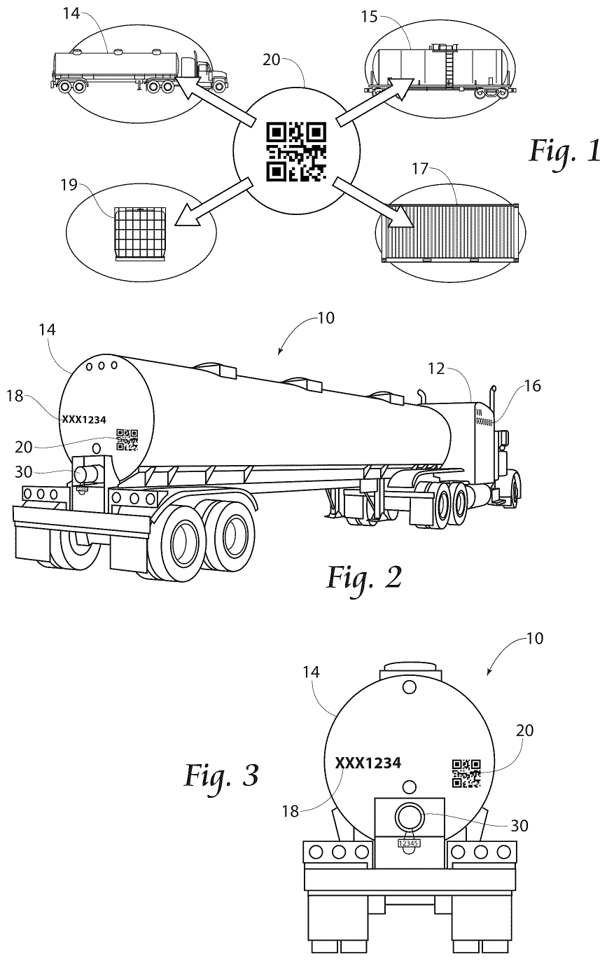

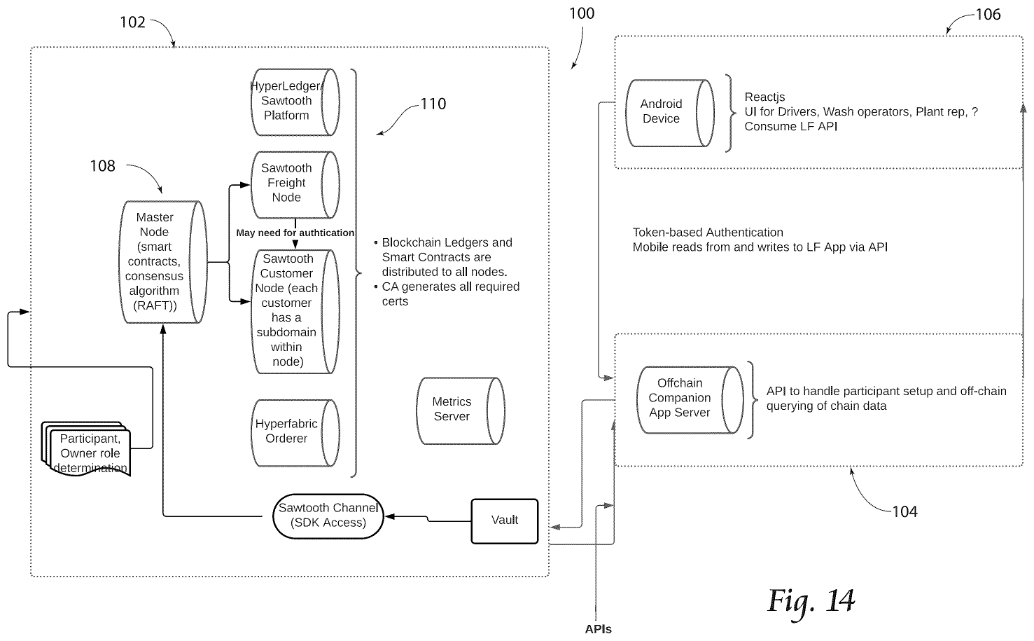

The invention employs a blockchain framework or platform, which is used to model the physical process flow of the transportation tracking system, including which physical elements need to be stored on and off of the block chain. The invention preferably employs a mobile application as the basis for carrying out the methods of the present invention. To better clarify and understand the present invention, a transportation process employing the invention is described below in FIGS. 1-13. The supporting programming and blockchain will be described in FIGS. 14-21, with the user interface described in FIGS. 22 and 23.

As an overview, FIG. 1 depicts potential uses for the present invention. A tracking device 20, e.g. a QR code or RFID, is implanted or attached to a transportation container, such as a tanker trailer 14, a train tanker 15, a shipping container 17 or a tote 19. These transportation containers will be secure, sealed containers that will meet particular characteristics. For example, these transportation containers may be required to meet certain dietary or food grade criteria, or certain temperature or pressure criteria. The present invention provides a custody chain that is secure and can record and monitor at various steps as to whether such criteria are maintain. The following is an example of the custody chain of the present invention.

FIG. 2 depicts a tanker truck 10 used for transportation of liquids, such as liquid food and dairy products. The truck 10 generally comprises a tractor or cab 12 and the trailer 14. Alternatively, the truck could comprise with the trailer affixed to the cab 12, e.g. the trailer is part of the trucks chassis. Typically, the trailer 14 will be a single tank-style trailer when transporting such liquid foods, but it is understood that the present invention can also be used for multi-tank style trailers. Each of the tractor 12 and the trailer 14 will have a respective vehicle identification number (VIN), 16 and 18, respectively. The VINs, 16 and 18 will help track the load within the trailer 14. These data elements, particularly the VIN 18, are the immutable and unalterable records that provide the backbone for the present invention. They provide the particular details of a load, if changed, will be recorded and detailed in the blockchain program of the present invention.

As shown in FIG. 3, the QR code 20 is located on the trailer 14 and will provide relevant information to the user when scanned by a user, with a user interface, such as using a scanning device 22. An example of such a device could be a smart phone (see FIG. 6). FIG. 2 depicts the truck 10, being initially entered and registered into the tracking system.

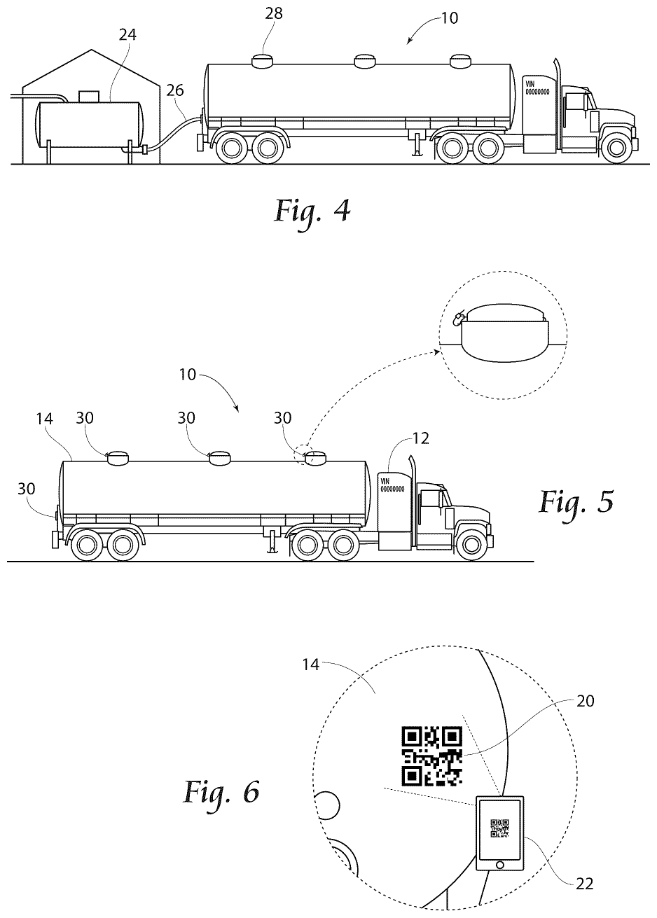

Once entered into the tracking system, the truck 10 will then be positioned to receive a load for transportation, as shown in FIG. 4. Typically, a holding tank 24 will be connected to trailer 14 by way of a hose 26 and the trailer 14 will be filled. Once filled, the hose 26 will be removed, and manhole cover or covers 28 will be shut and sealed, preferably with a zip tie or zip ties 30 or some other tamper proof device (see FIG. 5). These tamper proof devices would have an individual identification number associated with each device. A seal will also be located on the back valve, with the seal also having an identification number. The QR code 20 will be scanned again (see FIG. 5), and the contents of the trailer 14 will be recorded.

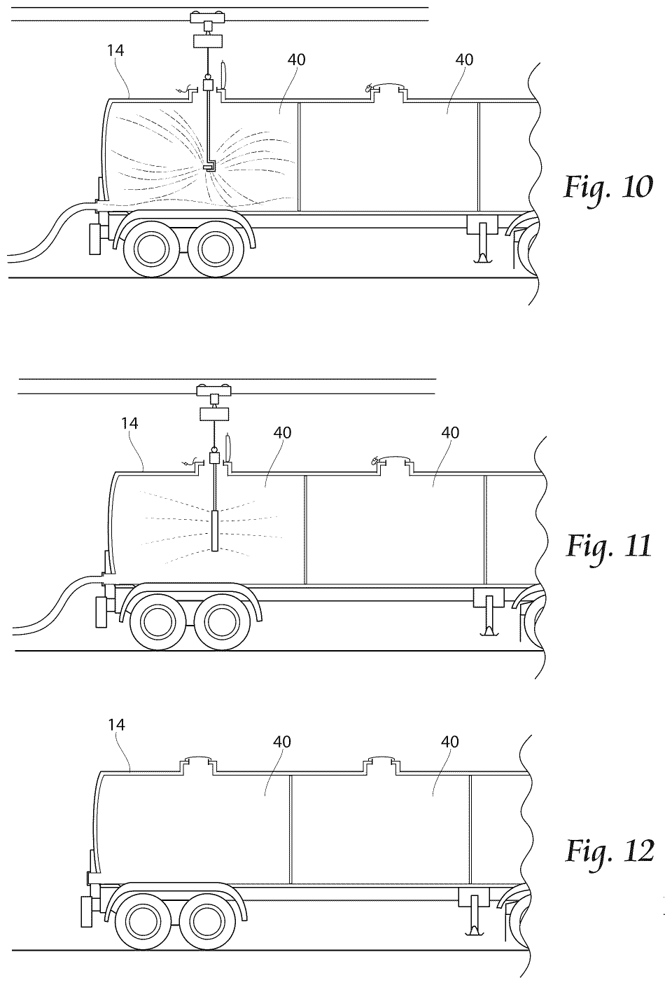

The truck 10 will proceed to an area for delivery, will be scanned again (FIG. 6), and the contents will be unloaded into a further holding tank 32. The receiving facility will scan the QR code 20 prior to receiving to verify all elements are in order prior to receiving. For example, all sealed orifices on the trailer will be verified as still being secure and in place. The empty truck (FIGS. 8 and 9) will proceed to an area where the trailer tank or tanks 40 will be washed (FIG. 10) and rinsed (FIG. 11). Once finished, zip ties 30 or other anti-tampering measures, can be applied to the manhole covers 28 with the individual identification number being recorded, as well as to the seal on the back valve and other openings hoses, etc., and the QR code 22 can be scanned again (FIG. 5). The trailer 14 is clean and ready for another load.

The process not only provides for assurances that the tank 14 is sanitized for another delivery, but also provides more particularly details on the sanitization process itself. This is especially important when sanitizing trailers and containers for to meet food grade requirements and certifications. Examples of such food grade requirements include Kosher or Halal certification, or certification that the container is allergen-free, Grade A, etc.

Furthermore such processes, e.g. cleaning, rinsing, sealing, etc., must happen within a particular period of time. As noted above, the present invention requires scanning of the trailer at each step of the procedure and eliminates manual entry of data at each step. The scanned information will not only have the specific wash cycle as a predefined set of data and/or inputs, it will also have a time and date stamp so that the process can be easily verified. The scanned information is recorded in blockchain, meaning that it cannot be removed or altered, providing secure and accurate insurance the cleaning process was carried out according to kosher practices and/or other wash practices.

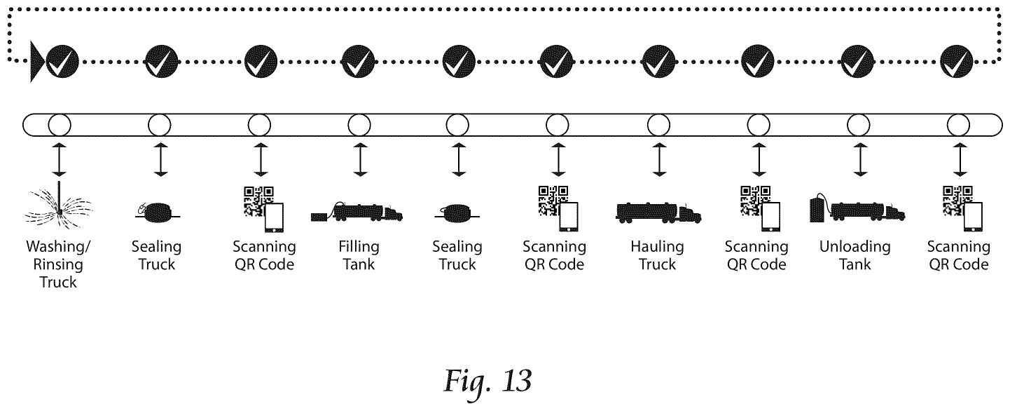

An example of the secure process is shown in FIG. 13, which is based on the blockchain based distributed ledger system of the present invention. The system has a central registry that allows for the persistence of the history of loads and cleaning events (critical events) to be stored in a verifiable digital format. The ledger system can be updated by a distributed set of agents (wash stations, loading facilities) and submitted to a central registry, which can then be used to generate automated reports for audits (e.g. Kosher, USDA, Dept. of Transportation (DOT)). Development of a central registry enables searching of data on loads during foodborne illness-related emergencies and can be more easily integrated with regulatory systems. It should be understood that the process is a continuous process, as the trailer 14 can be repeatedly washed and ready for a new load.

A blockchain is a distributed ledger that is similar to a database, but is not controlled by a central authority. Rather, the ledger is dispersed across multiple computers, located anywhere, and run and accessed with a network connection. Data is added and up-dated in real-time to the ledger and, once added, the data cannot be removed or edited as with a typical database. The decentralized ledger ensures that each of the computers within the network has the identical record or records. The blockchain essentially consists of cryptographically linked data on a secure network that is monitored and regulated with consensus protocols.

Each entry into the ledger is a “block” that is securely linked to the other “blocks” in the ledger, in a sequential order. For example, each transportation event, filling, washing, etc., discussed above, would be a block in the blockchain of the present invention. The added block is stored in each of the computers of the system, also referred to as nodes, and is validated.

An overview and an example of the blockchain ledger or system 100 of the present invention is shown in FIG. 14. The ledger 100 is based on multiple nodes, preferably using three-node or four-node clusters. The ledger 100 forms the base of the decentralized software platform of the present invention. The ledger 100 is a permissioned blockchain network, meaning that it is not open to any and all people but requires that participants be accepted into the network. Preferably, the network also may have various levels of permission, depending on the particular user.

The blockchain ledger 100 is based on open source code that is modified for specific uses. One example of source code that could be used in the present invention is Hyperledger Sawtooth source code.

Still referring to FIG. 14, the system 100 generally comprises a node portion 102, a supporting server portion 104, and a data entry portion 106. The node portion 102 includes a master node 108 and individual nodes 110, with the master node 108 providing a consensus algorithm for the individual nodes to communicate with one another. The master node 108 also includes the smart contracts, e.g., self-executing code, that are used for during the verification and certification processes. Examples of consensus algorithms include Paxos or RAFT. The individual nodes 110 include specific nodes related to each customer, freight load, and individual orderer on the system. The individual nodes may potentially also include the individual trucks or drivers that may be part of the transportation process. As the master node 108 interacts with the individual nodes 110, the blockchain ledger and the various smart contracts is distributed to all of the nodes. The certificate authority (CA) will generate all of the required certificates based on the data in the ledger, such as user enrollment, transactions invoked on the blockchain, and TLS-secured (transport layer security) connections between the nodes of the blockchain.

The node portion 102 of the system 100 interacts with the support server portion 104 of by way of tools such as a software development kit (SDK) and an encryption management system, such as Vault. The support server portion 104 of the system 100 is generally an application program interface (API) that handles the initial set-up of users or nodes to be entered into the system. The support server portion 104 also provides for questions to be answered outside and off of the blockchain data.

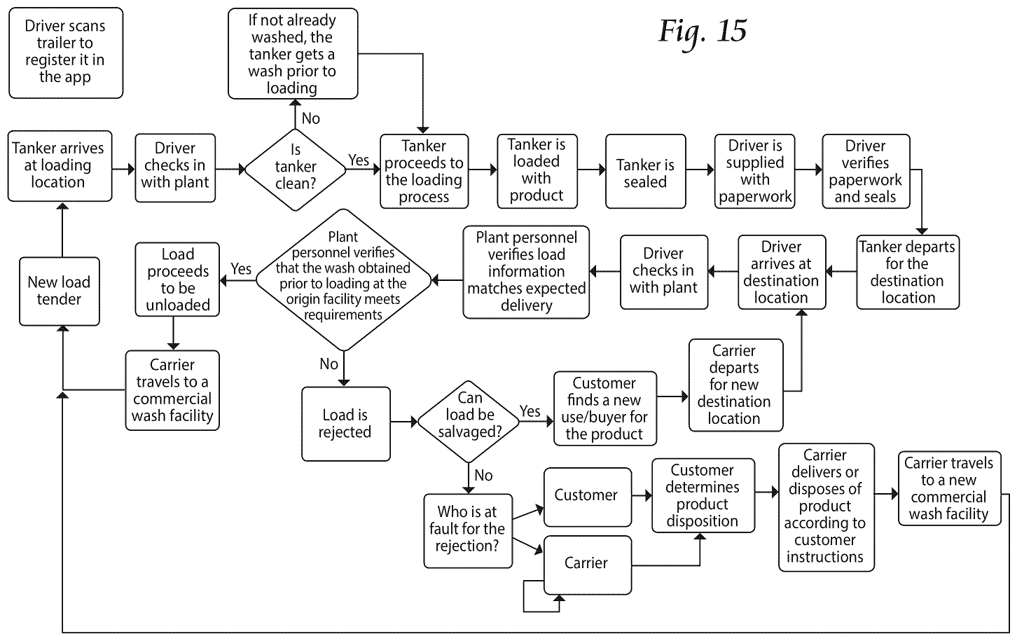

The third portion of the system 100 shown in FIG. 14 is the data entry portion 106. The data entry portion includes a smart device, such as an IOS, IPhone or an Android device that allows the user to enter information into the block chain. The smart device further provides an application and user interface (UI) for the user, with the application programmed with computer program, such as a JavaScript program, or another acceptable computer program. One example of a possible JavaScript program is React. The data entry portion 106 may be used by any of the various people associated with the system, such as truck drivers, tank wash operators, plant operators or representatives, each with a varying degree of permissions to enter or alter within the program. This is the general backbone for the present system and invention, described further in FIG. 15.

FIG. 15 provides a flow chart detailing the building of the blockchain ledger according to the present invention. The flow chart generally follows along the above described method in FIGS. 1-14, with further explanation if the trailer contents have been compromised in some fashion. The driver registers the trailer 15 by scanning the QR Code 20 (FIGS. 2, 3, and 6). Once registered, the trailer 14 and the driver arrive at the loading station, and the driver will check in. The QR code 20 will be scanned (FIG. 5) to determine if the trailer 14 and the trailer tank 40 was cleaned acceptably, the wash had not expired and contained acceptable prior products. If acceptable, the driver will proceed to a loading station (FIG. 4). If not, the truck 10 and the driver will proceed to a washing station (FIGS. 10 and 11). Once washed, the QR Code 20 will be scanned (FIG. 6), and the driver will proceed to a loading station and loaded with a product (FIG. 4).

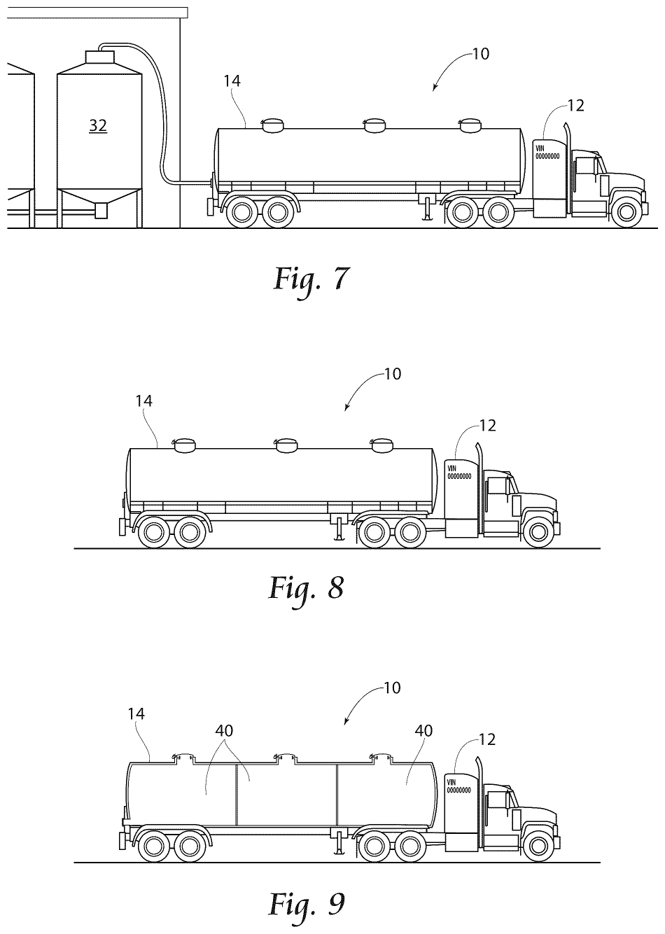

Once the tank 40 is filled, it will be sealed (FIG. 5), the driver is supplied with paperwork to verify the load and the seals. The QR code 20 will be scanned (FIG. 6) the seals entered and the product is verified. The driver proceeds to the delivery destination (FIG. 7). The personnel at the delivery destination will scan the QR code (FIG. 6) and verify that the load is correct and that the wash meets the facilities requirements. The tank 40 is then unloaded (FIG. 7). The driver then leaves (FIG. 8) and proceeds to a wash facility (FIGS. 9-12) to prepare for a new load. An example of what may be displayed to the wash facility could be:

TABLE 1
Trailer VIN: Z123456j789k97777
Previous Product #1-Grade A Raw Milk-Oct. 30, 2021
Wash type: Kosher-Hagen Tank Wash, Janesville, WI Oct. 29, 2021
Previous Product #2-Soy Sauce-Oct. 26, 2021
Wash type: Kosher-Ottery Brothers Tank Wash, Campbellsport, WI
Oct. 25, 2021
Previous Product #3-Vinegar-Oct. 23, 2021

Still referring to FIG. 15, when the driver arrives at the delivery station, there is a possibility that the scanned information is determined to be incorrect or incomplete, and the load is rejected. For example, if the tank 40 was not washed in accordance with prescribed conditions, e.g. was not deemed kosher, the wash is not shown, or the contents or the trailer ID or VIN do not match, the load would be rejected.

If, after rejection, the load can be sent for a different use, e.g. a non-kosher use, the driver would proceed to the new delivery station and proceed with scanning and delivery process as noted above. If a different use cannot be found for the load, there will be a determination of who (customer/producer or driver/carrier) is at fault. Once determined, the load will be disposed, and the truck will proceed to a wash station so that it can be washed, sealed, and made ready to receive a new load.

As demonstrated in FIG. 15, each necessary step along the way creates a new block for the blockchain, providing a secure transaction log. That is, each step that has information that is required for certification will create a block in the blockchain. Similarly, the blockchain is determinative of the particularities of the tank or container. If the details of a load are not consistent and do not purport to what is in the blockchain, the load will not be accepted. The recorded information cannot be changed or altered, as could be the case of written documentation by a person. Also, before storing information in a block, the data is hashed, which is a process of changing the entered data into a fixed-length hash value. While the data could be decoded, these fixed-length hashes form the blocks for ledger and cannot be “unhashed”. That is, since the hash is a single fixed data entry and not just the entry of all of the data, any change to the data will create a new hash, i.e. a new entry.

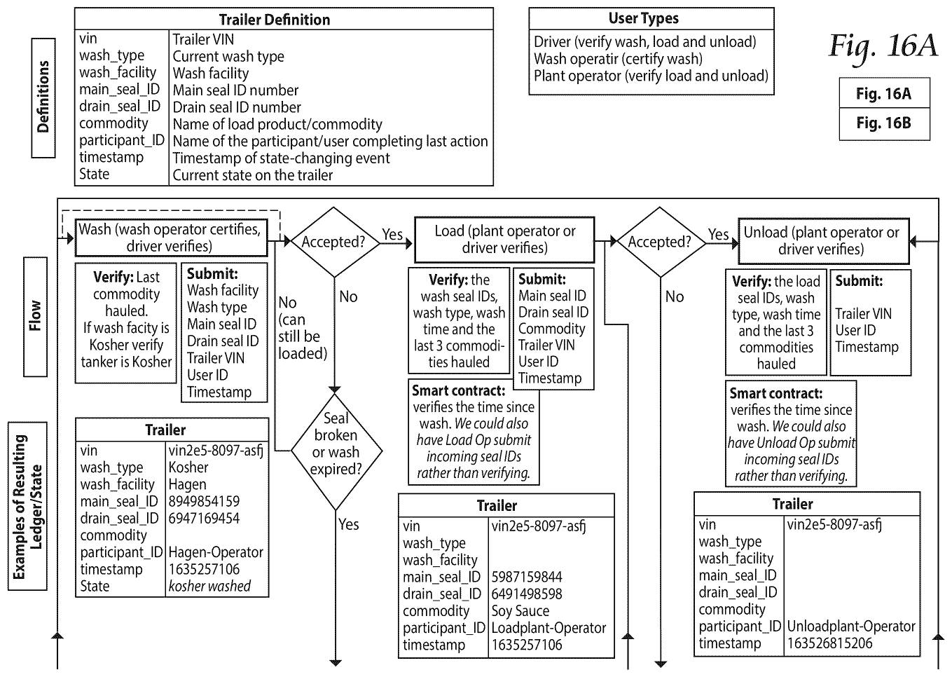

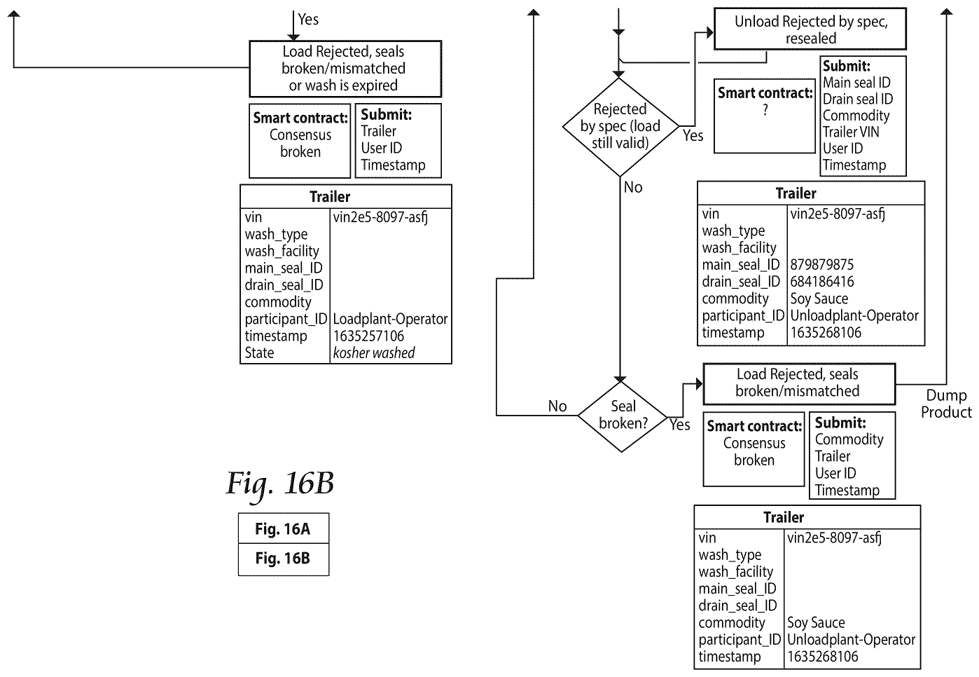

The present invention requires the various people associated with the processes, e.g. drivers, wash operators, plant operators, etc., to enter data necessary to build the blocks for the blockchain. FIGS. 16a and 16b provide a further detailed flowchart of the particular information that could be entered, preferably with an application on a smart device, and preferably with a drop down menu for the entry of the data. Once the QR Code is scanned, the main information will be entered into the application. This information includes the trailer VIN, the type of wash, e.g. Kosher, Pareve, etc., and where the wash took place, the ID numbers for the seals on the manhole covers 28 and the seals on the rear valve, the product being transported, and what was the last action performed for/on the load. There will also be a timestamp and locations entered, which preferably is facilitated with a GPS system.

FIGS. 16a and 16b further details potential information that is entered and may determine whether a particular load is accepted or not, or if and how a trailer should be washed. The wash operator will determine if they can perform a wash and then perform the wash. At a wash station, the washing operator will certify the wash and a determination will be made whether the truck can proceed to be loaded, or if the wash is rejected and will need to be rewashed. Once at the loading station, the plant intake operator will seal the trailer, verify the seals, verify the prior products, and verify the wash performed. The seals and the wash time/date, and other information will be entered, and the truck will be loaded. The truck will travel to where it will be unloaded, once the data presented from the scanned QR code is verified. If not verified, the load will proceed as previously discussed, with the load being delivered for a different use or discarded.

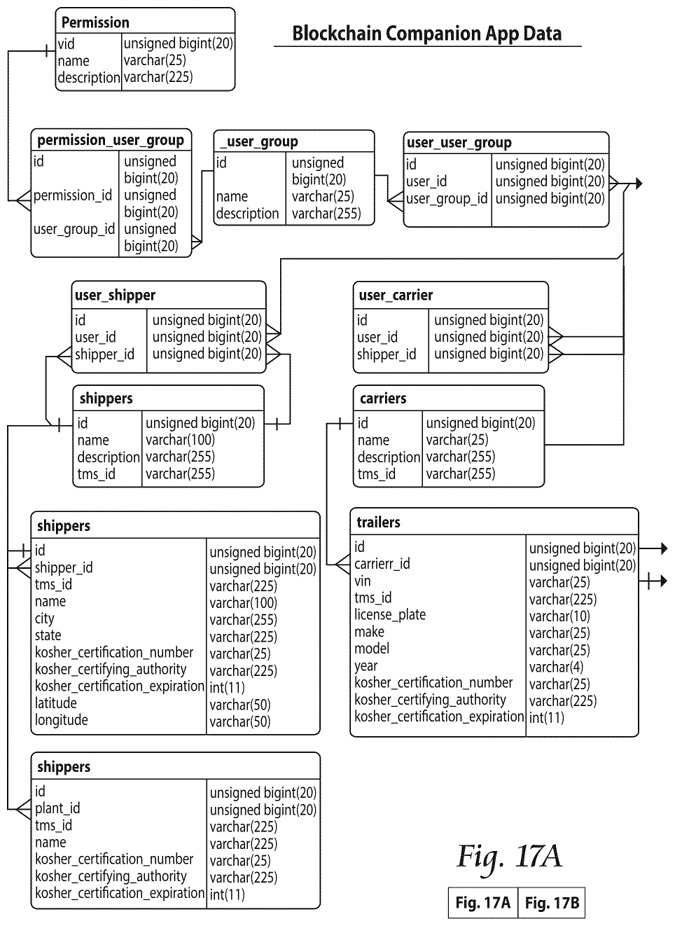

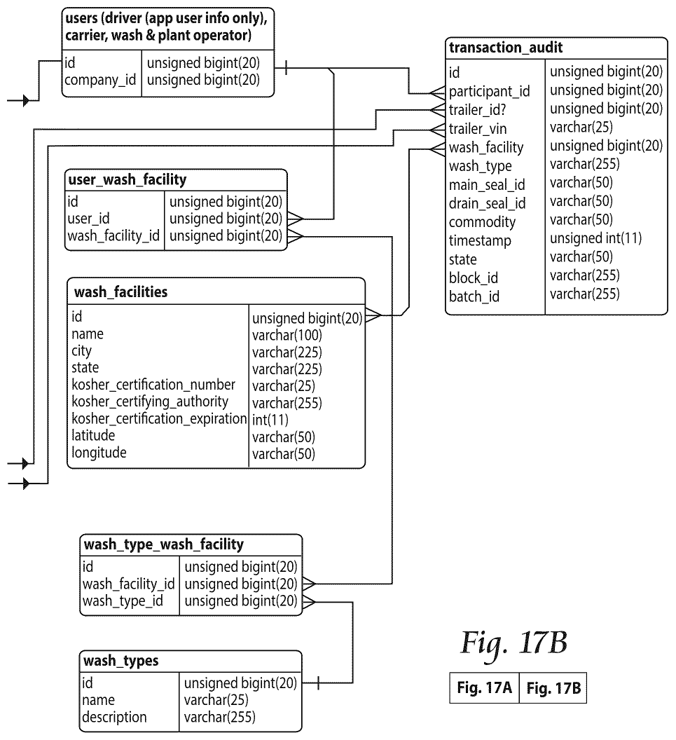

FIGS. 17a and 17b provides further details and data that may be entered into the program to form the blockchain ledger. That is, this is information entered into the application that gets sent through the API to the blockchain. For example, the various details of the vehicle, make, model, year, are entered, thereby making the certification process more efficient. Likewise, if the wash is a kosher wash, the certification details would also be entered. The details will provide a clear record of what is and has been entered into the system. Preferably, the transaction data is present in an encoded form, such as base64 format in “transaction”. “payload” field which needs to be decoded to get the original payload data saved to the network.

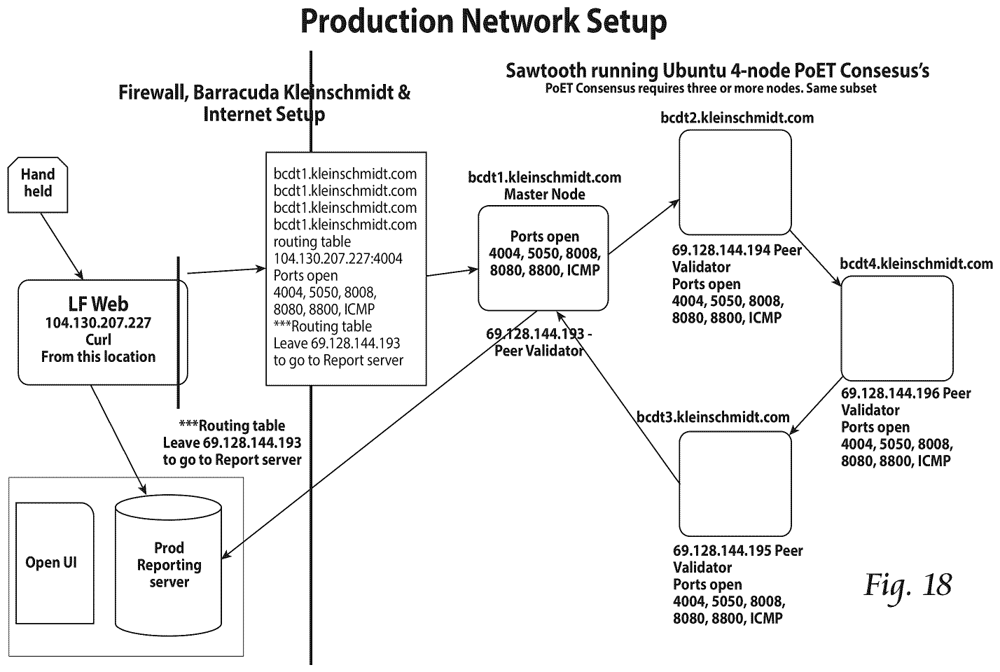

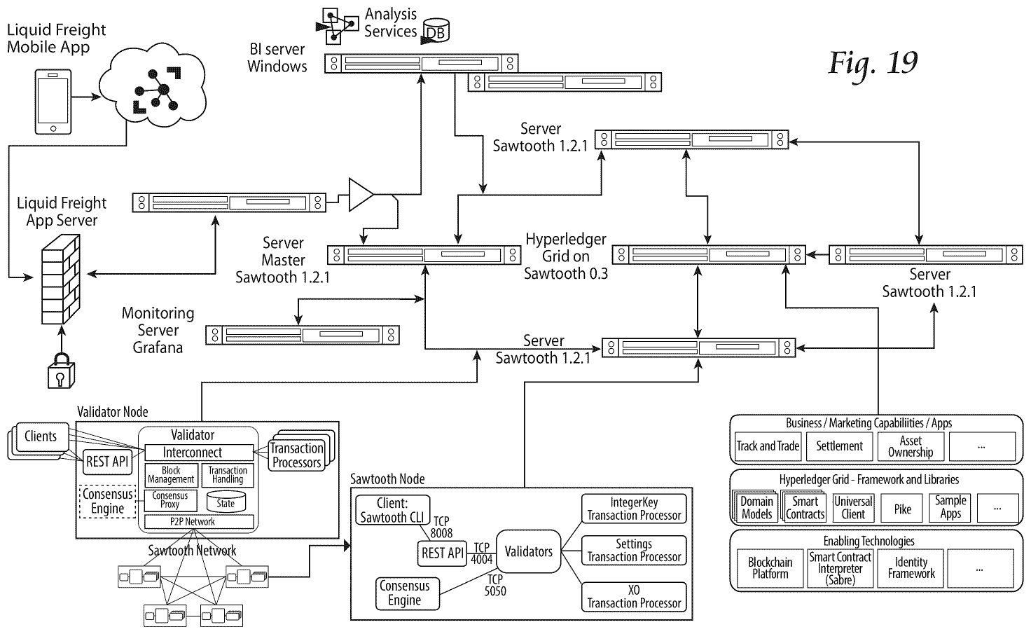

FIG. 18 shows another potential network setup according to the present invention. Information and data that may be stored in a zipped folder.

The following terminology will be used when describing the present invention.
1. Transaction Family: For saving data to hyperledger sawtooth blockchain, every kind of data needs its handler, called a transaction family. A new transaction family needs to be created for each type of data. Two families are inbuilt on sawtooth: “intkey” (an integer value) and “xo” (a tic-tac-toe game)
2. Transaction: Function that changes the state of the blockchain. Each transaction is put into a Batch, either alone or with other related transactions, then sent to the validator for processing.
3. Batch: Group of related transactions. In Sawtooth, a batch is the atomic unit of state change for the blockchain. A batch can contain one or more transactions. For a batch with multiple transactions, if one transaction fails, all transactions in that batch fail.
4. Node: Participant in Sawtooth network. Each node runs a single validator, a REST API, and one or more transaction processors (also called a peer).
5. State: Database that stores a local (validator-specific) record of transactions for the blockchain.
6. Transaction processor: Validates transactions and updates state based on the rules defined by the associated transaction family. Sawtooth includes transaction processors for the sample transaction families, such as identity-tp for the Identity transaction family.

7. Validator: Component responsible for validating batches of transactions, combining them into blocks, maintaining consensus with the Sawtooth network, and coordinating communication between clients, transaction processors, and other validator nodes.

Component bind string: When a validator will listen for incoming communication from the validator's components.

Network bind string: The validator will listen for incoming communication with other nodes.

Public endpoint string: The address that other peers use to find the validator on a node.

Consensus endpoint string: Determined by the validator listening for incoming communication from a consensus engine. This value will be set with bind consensus when starting the validator.

Peers list: These are the addresses that a validator will use to connect to other nodes, i.e. the public endpoint of those nodes.

The general set-up is as follows:

On a first terminal window, Login to the server using ssh: ssh <username>@104.130.207.227
2. On another terminal window, upload the zipped folder to the server using scp. Command: scp sample-sawtooth-transaction.zip <username>@104.130.207.227:˜
3. Move to the first terminal window and install a node version manager (nvm).
4. Verify the nvm.
5. Unzip the uploaded folder using unzip sample-sawtooth-transaction.zip (folder name: sample-sawtooth-transaction)
6. Move to the unzipped folder.
7. Install all node packages.

8. Two dependencies need to be run to do a transaction, i.e. transaction processor for the “TruckInfo” transaction family and another file that makes the transaction to save the data on hyperledger sawtooth blockchain.

9. The transaction processor needs to be run first, which connects to one of the nodes from the sawtooth network and starts a handler to handle the transaction for saving “TruckInfo” data.

10. The other file is for making a transaction which sends the transaction to the same sawtooth node on which the transaction processor is connected.

11. Once a transaction is sent to the blockchain using step 10, the transaction processor listens to it, processes the data and saves it to the blockchain.

FIG. 19 provides yet a further flowchart that demonstrates the potential of the present invention. As an example, the transaction processor is started and a transaction handler is created for a transaction family. For example, the transaction family may be named “TruckInfo.” The transaction handler is responsible for applying (saving, deleting, updating) the received transaction payload information to the blockchain. The program will process the information, which initializes the transaction family and transaction processor version and registers it to the network. The transaction handler listens to every transaction happening for the “TruckInfo” transaction family. The handler than uses a payload class to decode and validate the received encoded transaction payload. If the data is invalid, it rejects the transaction with an “Invalid Transaction” error. If the data is successfully parsed by the payload class, it is sent to the “TruckInfoState”. TruckInfoState is a class that initializes the context, helps load the data to the blockchain and retrieve it from the blockchain, as well. After the state context is initialized, the action specified in the payload is performed, which helps in manipulating the state of the blockchain, pushing the data to the node, and letting it synchronize with all the nodes.

When carrying out the above processes, preferably the same node is used on which the transaction processor and handler is started.

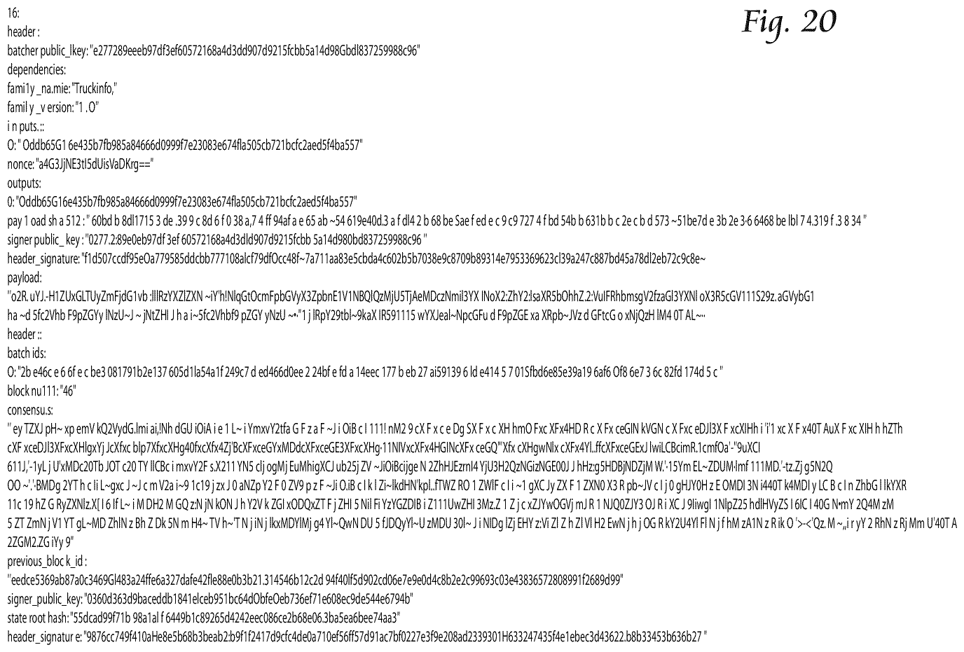

FIGS. 20 shows an example of hashed data used to establish the ledger for the present invention, and could be an example of data that could correlate to the delivery loads in Table 1. Because of the high level of encryption needed to insure a high level of confidence in the system, it can take a significant amount of time to query directly from the source data, making it more difficult to display “on chain” information at will to the day-to-day end users of the application. This challenge is solved by doing regularly scheduled chain “dumps” to pull the encrypted information down off the Blockchain and into an off-chain data repository (FIG. 14) where it can be more quickly and easily queried and assembled for display and reporting to the end users. While this data is not being pulled directly from the Blockchain when displayed in the application, all data that originated from the Blockchain can, with the correct permissions and upon request, be validated against the data's on chain source when needed and can be further certified through certification reporting generated against the on-chain data that displays the unencrypted data elements and their associated chain “keys” that corroborate the data.

It should be noted that the information will be entered after scanning the QR Code and will be entered in by a registered user. If the user is not registered, the scanned QR code will not allow the user to enter information, either with a message or warning or taking the user to a void URL.

It should be noted and understood that the above blockchain pathways and networks are exemplary of the invention, and it is understood that the pathways that are built and used would be modified for various situations. Provided that the pathways provide secure certifications as discussed through this specification, they would fall within the scope of the present invention.

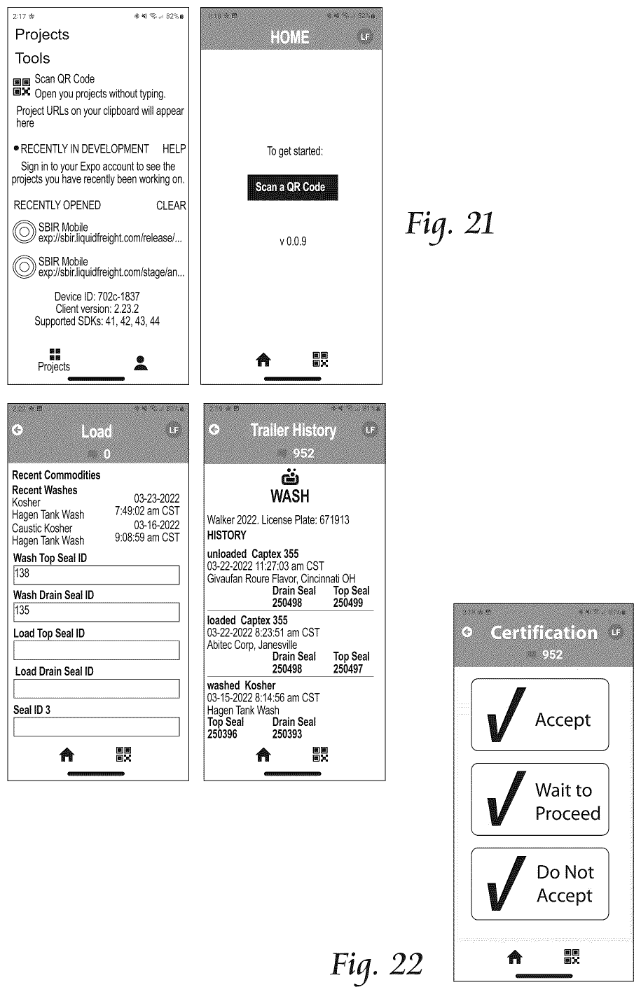

FIG. 21 shows various aspects of a possible user interface for entering data into the system. As discussed, the preferred entry form is an application on a smart device. The interface is designed to prompt you, e.g. scan a QR code, allow you to enter information, such as the seal IDs, and gives you a history of the entered information.

FIG. 22 is an example of an interface that could be shown with or on the device shown in FIG. 21. In FIG. 22, after scanning the code, the interface determines whether the certification should be accepted, whether follow-up information is required, or whether there is an issue with the certification and it should not be accepted.

The above processes and systems are described as transporting liquid food products. However, the present invention is also applicable for tracking other freight and loads. The current invention could be employed for use in hauling and transporting various liquids, e.g. liquid chemicals, so that there is a secure record of what is being transported within a particular trailer or tanker, if the trailer has been properly cleaned, and what has been previously carried within the tanker.

In particular, the present invention allows for verification and certification of the carriers and containers that must meet requirements for a particular transportation process. As noted, while food grade certifications are important uses for the present invention, the present invention can be utilized in other transportation processes where the characteristics of the carrier or container must be maintained throughout transport. For example, in certain situations the pressure or humidity must be maintained while in transit, and these conditions are presumed to be maintained by the specific container not being opened during the transportation process. That is, the present invention can be used to determine if any seals on such a container have been moved, changed, or altered during transport.

The system and methods provide an immutable record of the transported goods via block chain, or ‘write once read many’ databases, or an append-only ledger based storage, or other immutable data storage medium that can be verified at each step of the delivery process. While the current, original embodiment of the invention is based in blockchain technology, it is acknowledged that technology around data storage is a rapidly evolving technology and other immutable data sources that provide the complete and unaltered history of the transported goods may be utilized.

It is further appreciated that the immutable record established with the present invention could be carried out with other types of immutable storage besides the use of block chain methods and systems. Immutable storage is a type of storage protocol that protects stored data by preventing any changes or alterations for either a set or indefinite amount of time. Another example of immutable storage that could be employed in the present invention is an immutable ledger database, such as Amazon's Quantum Ledger Databases, QLDB, Microsoft's Azure confidential ledger, and Hyperledger Fabric, developed by IBM.

For example, QLDB is an append-only immutable journal or ledger that stores a sequenced, cryptographically verifiable entry of each change that is made. Those changes are chained together as blocks. This is similar to the use of blockchain, with the exception that blockchain utilizes distributed ledger technology and decentralization to address trust issues.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A non-transitory, computer readable medium storing one or more instructions executable by a computer system to perform operations for immutable storage processing, the instructions comprising:
receiving, from a user associated with an application based in an immutable storage medium, a request for a service;
in response to the request, identifying one or more electronic forms to be filled out;
generating a first unique identifier (ID) based on the request and a first digital content on the electronic form, wherein the first digital content is filled in by the user;
obtaining a first information-embedded digital content by embedding the first unique ID in the first digital content;
recording the first information-embedded digital content to a ledger database;
receiving, from a second user associated with an immutable storage medium application, a second request for said service;
in response to the request, identifying one or more of said electronic forms to be filled out;
generating a second unique identifier (ID) based on the second request and a second digital content on the electronic form, wherein the second digital content is filled in by the second user;
obtaining a second information-embedded digital content by embedding the second unique ID in the second digital content;
recording the second information-embedded digital content to said ledger database;
determining whether said first and said second information-embedded digital content are identical with one another.

2. The computer readable medium according to claim 1, wherein the instructions further comprise hashing the determined identical data.

3. The computer readable medium according to claim 1, wherein the instructions are directed towards certifying transportation of a product.

4. The computer readable medium according to claim 3, wherein said product is a food material.

5. The computer readable medium according to claim 4, wherein said food material is a liquid.

6. A computer-implemented method for tracking freight within a container, the method comprising:
receiving, from a user associated with an immutable storage application, a request for a service;
in response to the request, identifying one or more electronic forms related to said freight to be filled out;
generating a first unique identifier (ID) based on the request and a first digital content on the electronic form, wherein the first digital content is filled in by the user;
obtaining a first information-embedded digital content by embedding the first unique ID in the first digital content;
recording the first information-embedded digital content to the immutable storage application ledger;
receiving, from a second user associated with an immutable storage application, a second request for said service;
in response to the request, identifying one or more of said electronic forms to be filled out;
generating a second unique identifier (ID) based on the second request and a second digital content on the electronic form, wherein the second digital content is filled in by the second user;
obtaining a second information-embedded digital content by embedding the second unique ID in the second digital content;
recording the second information-embedded digital content to the immutable storage ledger;
determining whether said first and said second information-embedded digital content are identical with one another; and
hashing said first and said second information-embedded digital content.

7. The method according to claim 6, wherein said first and said second information-embedded digital content are related to the characteristics of the container.

8. The method of claim 7, further comprising the step of certifying that the characteristics of the container meet certain predetermined characteristics.

9. The method of claim 8, wherein said predetermined characteristics relate to food grading.

10. The method of claim 6, further comprising the steps of:
receiving, from a third user associated with an immutable storage application, a third request for said service;
in response to the request, identifying one or more of said electronic forms to be filled out;
generating a third unique identifier (ID) based on the third request and a third digital content on the electronic form, wherein the third digital content is filled in by the third user;
obtaining a third information-embedded digital content by embedding the third unique ID in the third digital content;
recording the third information-embedded digital content to said immutable storage ledger;
determining whether said third information-embedded digital content is identical with previously hashed first and second embedded digital content; and
hashing said third information-embedded digital content.

11. The method of claim 10 further comprising the step of issuing a certification based on said third information-embedded digital content.

12. A method for monitoring a container carrying a specific freight to determine whether or not the container maintains predetermined characteristics particularly related to said specific freight, the method comprising the steps of:
receiving, from a user associated with an immutable storage application, a request for a service;
in response to the request, identifying one or more electronic forms related to said container to be filled out;
generating a first unique identifier (ID) based on the request and a first digital content on the electronic form, wherein the first digital content is filled in by the user;
obtaining a first information-embedded digital content by embedding the first unique ID in the first digital content;
recording the first information-embedded digital content to an immutable storage ledger;
receiving, from a second user associated with an immutable storage application, a second request for said service;
in response to the request, identifying one or more of said electronic forms to be filled out;
generating a second unique identifier (ID) based on the second request and a second digital content on the electronic form, wherein the second digital content is filled in by the second user;
obtaining a second information-embedded digital content by embedding the second unique ID in the second digital content;
recording the second information-embedded digital content to said immutable storage ledger;
determining whether said first and said second information-embedded digital content are identical with one another; and
providing a certificate based on said first and said second information-embedded digital content.

13. The method of claim 12, wherein said container is a tank-style trailer.

14. The method of claim 13, wherein said specific freight is a liquid material.

15. The method of claim 14 wherein said liquid material is a food material.

16. The method of claim 15, wherein said food material is food grade material.

17. The method of claim 15, wherein said liquid material is kosher.

18. The method of claim 12, receiving, from a third user associated with an immutable storage application, a third request for said service;
in response to the request, identifying one or more of said electronic forms to be filled out;
generating a third unique identifier (ID) based on the third request and a third digital content on the electronic form, wherein the third digital content is filled in by the third user;
obtaining a third information-embedded digital content by embedding the third unique ID in the third digital content;
recording the third information-embedded digital content to said immutable storage ledger;
determining whether said third information-embedded digital content corresponds to said certificate; and
issuing a second certificate.

19. The method of claim 18, wherein said certificate and said second certificate certify that said container have maintained predetermined food grade qualities.

20. The method of claim 19, where said food grade qualities are kosher qualities.
